(19) United States
(12) Patent Application Publication
(10) Pub. No.: US 2012/0107945 A1
(43) Pub. Date: May 3, 2012

(54) CHEMICAL REAGENT FOR MEASURING THE LEVEL OF HALOGEN AGENTS, IN PARTICULAR IN SWIMMING-POOL WATER AND ASSOCIATED MEASUREMENT METHOD

(75) Inventor: Zbigniew Stadnicki, Cales (FR)

(73) Assignee: PACIFIC INDUSTRIE, BOULAZAC (FR)

(21) Appl. No.: 13/322,883

(22) PCT Filed: May 28, 2010
(86) PCT No.: PCT/EP2010/057496

§ 371 Date: Jan. 13, 2012

(30) Foreign Application Priority Data
May 28, 2009 (FR) 0902580

(51) Int. Cl. G01N 21/59

(52) U.S. Cl. 436/125

(57) ABSTRACT

The present invention relates to a chemical reagent for measuring the halogen-agent content, in particular in swimming pool water, and also to an associated measurement method, and such that the chemical reagent, according to the invention, comprises a polysaccharide, an acid stabilizer compound, potassium iodide, a dye, and distilled water.

The present invention relates to a chemical reagent for measuring the content of halogen agents in particular in swimming pool water, and also to an associated measurement method.

The invention advantageously finds application in the field of filtering and monitoring swimming pool waters, by tracking the concentration of chlorine or bromine in residential swimming pool water.

Nevertheless, although particularly designed for such an application, the chemical reagent and the associated method could be used for monitoring and treating water in collective swimming pools, in particular in spas, or indeed a wide variety of pools and in particular Jacuzzis or even aquariums.

### BACKGROUND OF THE INVENTION

In the field of filtering and monitoring swimming pool water, the concentration of sanitizer is regularly monitored firstly to avoid any health risk and secondly to optimize the consumption of halogen-containing sanitizer.

For this purpose, various chemical reagents are used that enable manual methods to be implemented that are based on using reagent-soaked strips for dipping in the water, or indeed automatic methods, in which the reagent is mixed with swimming pool water and then the mixture is introduced into an analysis chamber for performing various types of measurement, and in particular colorimetric measurements.

The prior art is illustrated in particular by document WO 97/12242 A1.

The present invention lies in the field of automatically measuring the halogen-agent content so as to be able to determine the concentration of halogen agents such as chlorine or bromine without manual intervention.

Until now, the chemical reagent commonly used for measuring the content of halogen agents, namely the diethyl phenylene diamine (DPD), is transparent and it takes on a special color only when it reacts with water that has a sufficient concentration of halogen agents. A drawback of the reagent used lies in the fact that present methods based on optical measurements cannot distinguish between the situation in which the water for analysis contains no halogen agents and the situation in which the chemical reagent has not been mixed with the water for analysis. In both situations the mixture does not vary optically and remains transparent. This impossibility of distinguishing between the two above-mentioned situations is problematic insofar as when present methods detect no reaction it is deduced that the concentration of halogen agents is zero, whereas the concentration might in fact be above an authorized threshold.

Furthermore, the use of DPD as a chemical reagent is problematic since that reagent presents a high level of toxicity. That reagent is classified as toxic according to the REACH Directive and consequently it is no longer usable in the European market; there is therefore a great advantage in proposing a chemical reagent having a new formulation that can be used without risk of toxicity.

### OBJECT OF THE INVENTION

An object of the present invention is to mitigate the lack of non-toxic reagent for performing measurements using automatic methods and to propose a chemical reagent that makes it possible quickly and accurately to determine the concentration of halogen agents in a solution, without running the risk of a wrong measurement due to an absence of reagent.

### SUMMARY OF THE INVENTION

To this end, the invention provides a chemical reagent for measuring the halogen-agent content in particular in swimming pool water the reagent comprising, according to the invention, a polysaccharide, an acid stabilizer compound, potassium iodide, a dye, and distilled water.

Preferably, the reagent of the invention also includes a basic compound, in particular caustic soda.

### BRIEF DESCRIPTION OF THE DRAWINGS

The present invention can be better understood on reading a detailed example of an embodiment with reference to the accompanying drawing provided by way of non-limiting example and plotting the absorption curve of the water/reagent mixture as a function of the chlorine concentration of the water.

### DETAILED DESCRIPTION OF THE INVENTION

The chemical reagent in a particular embodiment of the invention comprises the following items:
a polysaccharide;
an acid stabilizer compound;
potassium iodide;
caustic soda;
a dye; and
distilled water.

The dye is preferably azorubine, where this non-toxic red dye is also known as a food color under the reference E122. Nevertheless, other dyes, of red or other colors, could naturally be used equally well.

The dye serves to detect the presence of the chemical reagent in the mixture, and consequently to make it possible to distinguish between the situation in which the water does not contain halogen-containing agents, and therefore does not react in the presence of the chemical reagent, and situations in which the chemical reagent has not been injected into the mixture.

For this purpose, the method includes a step of colorimetric verification of the mixture.

Advantageously, the polysaccharide is provided in the form of potato starch.

The acid stabilizer is hydrochloric acid, however other acids could equally well be used.

Advantageously, the chemical reagent includes:
8% to 10% polysaccharide;
2% to 3% hydrochloric acid;
2.5% to 3.5% potassium iodide;
2% to 3% caustic soda; and
0.5% to 1.5% dye.

The chemical reagent is prepared in several steps. In the first step, the polysaccharide, the acid stabilizer compound, and the potassium iodide are hydrolyzed while hot.

In a second step, the result of the hydrolysis step is cooled to ambient temperature. Finally, in a third step, at the end of the second step, the caustic soda, the dye, and the distilled water are added.

In a preferred embodiment of the invention, the chemical reagent comprises, per liter (L) of reagent:
91 grams (g) of 20% potato starch;
23 milliliters (mL) of hydrochloric acid;
30 g of potassium iodide;
23 mL of caustic soda;
10 mL of dye; and
864 mL of distilled water.

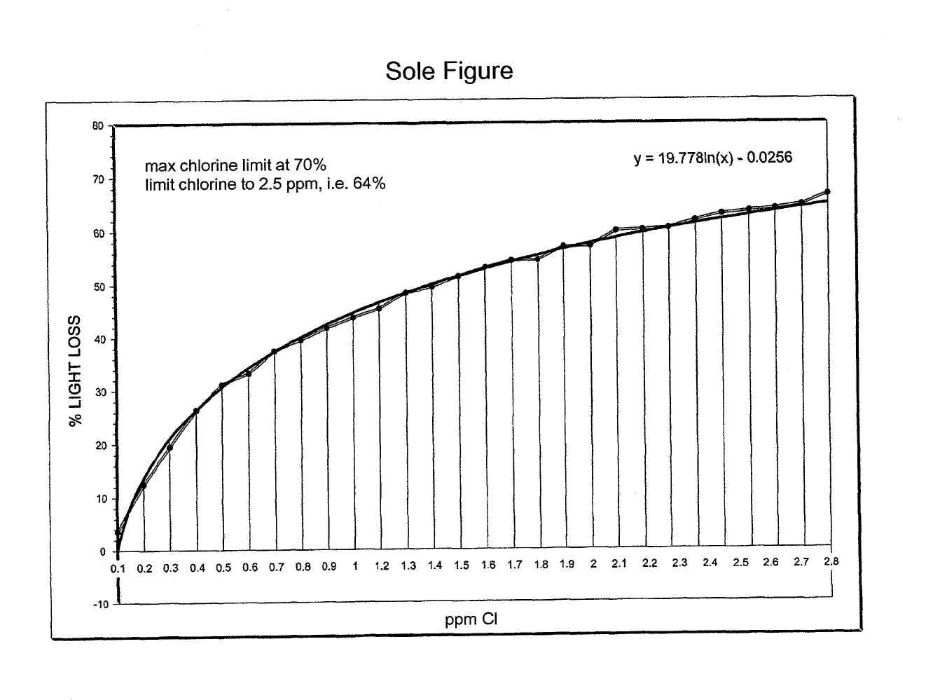

This composition is particularly suitable for measuring swimming pool waters, and if reference is made to FIG. 1 there can be seen a reference curve for light absorption by the water/reagent mixture as a function of the concentration of chlorine in the water. The graph plots the quantity of chlorine in parts per million (ppm) along the abscissa and the absorbent percentage of a water/reagent mixture up the ordinate.

The reagent is very suitable since it enables an accurate measurement to be made for chlorine concentrations lying in the range 0.1 ppm to 2.8 ppm, the quantity of chlorine in a swimming pool generally being required to be less than 2.5 ppm. A small variation of concentration in this range of 0.1 ppm to 2.8 ppm gives rise to a modification in the absorption percentage of the mixture that can easily be detected by conventional appliances. By way of example, a reduction in chlorine concentration from 2.5 ppm to 1 ppm gives rise to the absorption percentage varying by 20 percentage points, going from 64% to 44%.

Furthermore, this reagent presents high reactivity and water can be analyzed a few seconds after the water/reagent mixture has been inserted into the analysis chamber.

The measurement method used with the above-described chemical reagent includes a step of putting the reagent into contact with a volume of water for analysis, a step of verifying the presence of the reagent, a step of measuring the absorbence of the mixture, and a step of comparing the measurement that is obtained in the preceding step with a reference curve so as to determine the halogen content in the swimming pool water.

The first step is preferably performed by introducing a volume of swimming pool water into one port of a three-port mixer and in parallel injecting a measured quantity of reagent via a second port of the mixer.

The mixture leaves the mixer via the third port and is then injected into an analysis chamber enabling the “verification” second step to be performed. In this step, an optical sensor verifies the presence of the color of the dye in the mixture and serves to avoid making a measurement error in the third step as a result of an absence of reagent.

The “measurement” third step advantageously consists in illuminating the analysis chamber and in measuring the light absorbed by the mixture.

Once this measurement has been obtained, the method then consists in a fourth step in comparing said value with a pre-established reference curve as shown in FIG. 1 for analyzing chlorine-containing water.

The absorbence measurement obtained in the preceding step and the relationship between the absorbence of the mixture and the concentration of chlorine, as shown in FIG. 1, enable the concentration of the mixture to be determined.

Once the chlorine content has been determined, the method may include additional steps enabling a sanitizer agent dispenser to be controlled so as to regulate the quantity of sanitizer agent for pouring into the swimming pool automatically as a function of the real-time concentration of chlorine.

Another additional step consists in performing further measurements on the same sample or on a new sample, possibly while changing the proportions between the water for analysis and the chemical reagent.

Other characteristics of the invention could equally well be envisaged without thereby going beyond the ambit of the invention as defined by the following claims.

By way of example and in a variant, the second and third steps of the method could be performed simultaneously.

Although in the implementation described in detail herein it is stated that the reagent contains a basic compound, specifically caustic soda, thereby making the reagent particularly suitable for swimming pool water, this compound could be omitted, or some other basic compound could be used.

1. A chemical reagent for measuring the halogen-agent content in particular in swimming pool water, wherein the reagent comprises a polysaccharide, an acid stabilizer compound, potassium iodide, a dye, and distilled water.

2. A chemical reagent according to claim 1, wherein the dye is azorubine.

3. A chemical reagent according to claim 1, wherein the polysaccharide is provided in the form of potato starch.

4. A chemical reagent according to claim 1, wherein the acid stabilizer is hydrochloric acid.

5. A chemical reagent according to claim 1, further including a basic compound, in particular caustic soda.

6. A chemical reagent according to claim 1, wherein the chemical reagent includes:
8% to 10% polysaccharide;
2% to 3% hydrochloric acid;
2.5% to 3.5% potassium iodide;
2% to 3% caustic soda; and
0.5% to 1.5% dye.

7. A chemical reagent according to claim 1, wherein the chemical reagent comprises, per liter of reagent:
91 g of 20% potato starch;
23 mL of hydrochloric acid;
30 g of potassium iodide;
23 mL of caustic soda;
10 mL of dye; and
864 mL of distilled water.

8. A method of measuring the content of halogen agents in particular in swimming pool water by using a chemical reagent according to claim 1, the method comprising:
a step of putting the reagent into contact with a volume of water for analysis;
a step of verifying the presence of the reagent in the mixture;
a step of measuring the absorbence of the mixture; and
a step of comparing the measurement obtained in the preceding step with a reference curve so as to determine the halogen content in the swimming pool water.
